(19) United States
(12) Patent Application Publication
(10) Pub. No.: US 2026/0366165 A1
(43) Pub. Date: Nov. 19, 2026

(54) POST-RINSE PRETREATMENT WITH AQUEOUS COMPOSITIONS CONTAINING ALKALINE EARTH METAL IONS

(71) Applicants: CHEMETALL GMBH, Frankfurt (DE); BASF COATINGS GMBH, Muenster (DE)

(72) Inventors: Laurence CASTLE, Milton Keynes (GB); Thomas KOLBERG, Frankfurt (DE); Lukas KAULING, Frankfurt (DE); Thorsten GELBRICH, Muenster (DE); Thorsten LUECKERATH, Frankfurt (DE)

(21) Appl. No.: 19/126,334

(22) PCT Filed: Nov. 14, 2023
(86) PCT No.: PCT/EP23/81772

§ 371 Date: May 1, 2025

(30) Foreign Application Priority Data
Nov. 15, 2022 (EP) 22207587.1

(51) Int. Cl. C23C 22/34; C23C 22/68; C23C 22/76; C23C 22/80; C23C 22/83

(52) U.S. Cl. CPC C23C 22/34; C23C 22/68; C23C 22/76; C23C 22/80; C23C 22/83

(57) ABSTRACT

Disclosed herein is a method for pretreatment of at least one metal surface of a substrate, the method including at least steps 1) and 2), namely, contacting the at least one surface of the substrate at least in portion with an acidic aqueous composition AAC to form a film at least in portion on said surface (1), and rinsing the film obtained after step 1) prior to any optional curing and/or drying of said film with an aqueous composition AC, which is different from acidic aqueous composition AAC. Further disclosed herein are a method of applying at least one coating film onto at least one surface of a substrate that has undergone the pretreatment method, a substrate obtained by these methods, a method of using the aqueous composition AC, and a kit-of-parts including an acidic aqueous composition AAC and an aqueous composition AC.

The present invention inter alia relates to a method for pretreatment of at least one surface of a substrate, wherein said surface is at least partially made of at least one metal and/or alloy thereof, the method making use of a chemical, fluoride anions containing, pretreatment composition, and a subsequent post-rinse step, a method of applying at least one coating film such as an electrodeposition coating film onto the surface of a substrate, which has been pretreated in accordance with said pretreatment method, and a substrate obtainable by one of these methods.

### BACKGROUND OF THE INVENTION

Before substrates having metallic surfaces are being lacquered, i.e., before permanent coating layers are applied onto their surfaces, they are nowadays typically subjected to an anti-corrosive and adhesion-promoting chemical pretreatment by using a suitable chemical pretreatment composition. Often, aqueous solutions based on metal complex fluorides such as titanium and/or zirconium complex fluorides are used as such chemical pretreatment compositions in order to generate a conversion coating layer on the metallic surfaces of the substrates. As mentioned before, such a chemical pretreatment step is performed prior to subsequent coating steps such as an electrodeposition coating step, a coating with primer fillers, basecoats and clearcoats or powder coats. After having subjected the metallic surfaces of the substrates to a chemical pretreatment, often the resulting conversion coating films are rinsed afterwards in a “post-rinse” step using deionized water to remove excessive ingredients of the chemical pretreatment composition. It is known to use alkaline aqueous compositions or nitrite containing aqueous compositions as post-rinse compositions instead of deionized water in order to further improve the anti-corrosive properties of the conversion-coated surfaces of the metallic substrates, in particular to avoid flash-rusting in case of substrates made of cold rolled steel (CRS).

After chemical pretreatment subsequent coating steps are usually performed as mentioned hereinbefore. In particular, when substrates intended to be used in the automotive industry have undergone said chemical pretreatment, usually an electrodeposition coating layer is subsequently applied on top of their conversion-coated surfaces for further protection against corrosion. In general, there are anodically and cathodically depositable electrodeposition coating material (electrocoat) compositions, but cathodically depositable materials have the greatest importance in industrial coating and particularly in automotive coatings.

Due to the chemical pretreatment method performed and the parameters used and, further, depending on the kind of metal(s) of the metallic surfaces of the substrates used, but in particular depending on the kind of chemical pretreatment composition and its constituents used, sometimes undesired surface defects/differences in the surface properties of the resulting conversion coated substrates are observed. These differences in the surface properties of the substrates may in turn lead to differences in the application process, when subsequently applying an electrodeposition coating material composition onto their surfaces. In particular, as a result of the different surface properties of the conversion-coated substrates, differences in film build height (“mapping”) of the electrodeposition coating film during its application, a layer thickness of the electrodeposition coating layer, which is too large (too thick), and/or other appearance defects may occur and be observed. This in particular applies when the chemical pretreatment compositions used contain fluorides, since the fluorides contained in the conversion coating layers present on the metallic surfaces may migrate into the applied electrocoat material and negatively influence the film build height and cause mapping and/or cause the aforementioned appearance defects, in particular when the metallic surfaces or at least areas of these surfaces have been contacted with the pretreatment composition for a too long period of time. The occurrence of different film build heights of the electrocoat material within one layer is undesired as these differences need to be covered and levelled out by the subsequently applied coating material compositions (on top of the electrocoat layer) such as primer coating materials in order to prevent telegraphing to the surface of the total automotive coating. Such a covering and/or levelling out often requires a cost-intensive post-treatment process, which has to be performed manually, e.g., by manual grinding operations, after the electrocoat material has been already applied. Likewise, the occurrence of the aforementioned appearance defects is also undesired, in particular, since these may still be visible, even when further coating layers including a topcoat have been applied. A layer thickness of the electrodeposition coating layer, which is too large (too thick), is also undesired, since this could lead to an inacceptable surface roughness of this layer, which in turn makes a smooth application of further coating layers on top more difficult.

Thus, there is a need to provide a chemical pretreatment method making use of a fluoride anions containing chemical pretreatment composition, which allows a formation of a homogeneous film build without the occurrence of mapping during application of a subsequently to be applied electrodeposition coating material onto the chemically pretreated metallic surface of the substrate and without the occurrence of optical defects, in particular even when at least a portion of the surface of the substrate had been in contact with the chemical pretreatment composition for a too long period of time.

### Problem

It has been therefore an objective underlying the present invention to provide a chemical pretreatment method making use of a fluoride anions containing chemical pretreatment composition, which allows a formation of a homogeneous film build without the occurrence of mapping during application of a subsequently to be applied electrodeposition coating material onto the chemically pretreated metallic surface of the substrate and without the occurrence of optical defects, in particular even when at least a portion of the surface of the substrate had been in contact with the chemical pretreatment composition for a too long period of time.

### Solution

This objective has been solved by the subject-matter of the claims of the present application as well as by the preferred embodiments thereof disclosed in this specification, i.e., by the subject matter described herein.

A first subject-matter of the present invention is a method for pretreatment of at least one surface of a substrate, wherein said surface is at least partially made of at least one metal and/or alloy thereof, the method comprising at least steps 1) and 2), namely,
1) contacting the at least one surface of the substrate at least in portion with an acidic aqueous composition AAC, which at least contains fluoride anions, preferably in an amount in a range of from 10 to 2000 mg/L, calculated as fluorine, and which further preferably comprises at least one metal cation selected from the group consisting of titanium, zirconium and hafnium ions and mixtures thereof, to form a film at least in portion on said surface, and
2) rinsing the film obtained after step 1) prior to any optional curing and/or drying of said film with an aqueous composition AC, which is different from acidic aqueous composition AAC, and which contains at least one kind of alkaline earth metal ions.

A further subject-matter of the present invention is a method of applying at least one coating film onto at least one surface of a substrate, the method comprising at least steps 1) and 2) as defined hereinbefore and hereinafter and, further, a step 3), namely
3) applying a coating material composition comprising at least one film-forming polymer onto an optionally dried and/or optionally cured film, which film in turn is obtainable after having performed rinsing step 2), optionally after having further dried and/or cured the film obtained after rinsing step 2).

Preferably, the coating material composition applied in step 3) is an electro-depositable, preferably a cathodically depositable, coating material composition, wherein the at least one film-forming polymer present therein preferably is an electro-depositable, preferably a cathodically depositable, polymer.

A further subject-matter of the present invention is a substrate obtainable by the inventive pretreatment method comprising at least steps 1) and 2) or by the inventive method of applying at least one coating film onto at least one surface of a substrate comprising at least steps 1) and 2) or by the inventive pretreatment method as well as step 3).

A further subject-matter of the present invention is a use of an aqueous composition AC as defined hereinbefore and hereinafter, e.g., in connection with step 2) of the inventive pretreatment method,
for rinsing a film obtainable from applying an acidic aqueous and fluoride anions containing composition, preferably from applying acidic aqueous composition AAC as defined hereinbefore and hereinafter, e.g., in connection with step 1) of the inventive pretreatment method, at least in portion onto at least one surface of a substrate, wherein said surface is at least partially made of at least one metal and/or alloy thereof, and wherein rinsing is to be performed prior to any optional curing and/or drying of said film,
and/or
for at least partially reducing the fluoride content of a film obtainable from applying an acidic aqueous and fluoride anions containing composition, preferably from applying acidic aqueous composition AAC as defined hereinbefore and hereinafter, e.g., in connection with step 1) of the inventive pretreatment method, at least in portion onto at least one surface of a substrate, wherein said surface is at least partially made of at least one metal and/or alloy thereof, preferably by rinsing said film with the aqueous composition AC prior to any optional curing and/or drying of said film,
and/or
for improving the homogeneity of the film build and/or for reducing the mapping of a coating film CF at least in one of its areas, the coating film CF being obtained from applying an electrodeposition coating material composition over a cured or dried film, which in turn is obtainable from applying an acidic aqueous and fluoride anions containing composition, preferably from applying acidic aqueous composition AAC as defined hereinbefore and hereinafter, e.g., in connection with step 1) of the inventive pretreatment method, at least in portion onto at least one surface of a substrate, wherein said surface is at least partially made of at least one metal and/or alloy thereof, preferably by rinsing said film with the aqueous composition AC prior to any optional curing and/or drying of said film and prior to the application of coating film CF.

A further subject-matter of the present invention is a kit-of-parts comprising an acidic aqueous composition AAC, which at least contains fluoride anions, as defined hereinbefore and hereinafter, e.g., in connection with step 1) of the inventive pretreatment method, and
an aqueous composition AC, which contains at least one kind of alkaline earth metal ions and is different from acidic aqueous composition AAC, as defined hereinbefore and hereinafter, e.g., in connection with step 2) of the inventive pretreatment method.

It has been in particular surprisingly found that the inventive pretreatment method allows for a homogeneous film build during application of a subsequently to be applied electrodeposition coating material onto the chemically pretreated metallic surface of the substrate, independently of the metal substrate material used despite the presence of fluoride anions in the chemical pretreatment composition used in step 1). It has been unexpectedly found that no or at least significantly reduced undesired film-build deviations (mapping) due to different surface properties of the substrate as a result of the chemical pretreatment step 1) are observed, when applying and during application of an electrodeposition coating material composition onto the pretreated surface, which surface has, prior to that, undergone the rinsing step 2). It has been in particular found that this unexpected technical effect is a result of the specific aqueous composition AC used as rinsing composition in step 2) and its content of at least kind of alkaline earth metal ions present therein. It has been found that due to presence of at least kind of alkaline earth metal ions in the rinsing composition used in step 2), the amount of fluoride incorporated into the pretreatment film (conversion film) obtained after step 1) can be reduced and that as a result of that any negative influence of the fluoride anions on the electrocoat film build can be prevented or at least significantly reduced during electrocoat application. In particular, less migration of fluoride into the electrocoat film is observed upon application of the electrocoat composition such as by dipping of the pretreated substrate into an electrodeposition beath, which results in a reduced conductivity when voltage is applied, which in turn advantageously leads to a thinner electrodeposition coat layer.

Moreover, it has been found that—besides the improved homogeneity of the film build of a subsequently to be applied electrodeposition coating material composition—also the corrosion protection of the substrate is not negatively influenced. In addition, it has been found that also negative optical defects such as occurrence of runners are not observed in the layer obtainable from a subsequently to be applied electrodeposition coating material composition, in particular since a localized high fluoride concentration in the pretreatment obtained after step 1) is prevented by performance of rinsing step 2). Furthermore, it has been found that other properties of a layer resulting from a subsequently to be applied electrodeposition coating material composition such as the surface roughness are not negatively influenced as well, in particular that a layer thickness, which is too high, can be avoided.

Furthermore, it has been surprisingly found that the aforementioned unexpected results are in particular even observed when at least a portion of the surface of the substrate had been in contact with the chemical pretreatment composition for a too long period of time. Hence, the inventive method overcomes the paint defects of runners and mapping observed in conventional prior art chemical pretreatment methods and allows a thinner and smoother electrodeposition coating material layer to be formed.

### DETAILED DESCRIPTION OF THE INVENTION

The term “comprising” in the sense of the present invention, in connection for example with compositions AC and AAC, preferably has the meaning of “consisting of”. With regard, e.g., to compositions AC and AAC it is possible—in addition to all mandatory constituents present therein—for one or more of the further optional constituents identified hereinafter to be also included therein. All constituents may in each case be present in their preferred embodiments as identified below.

The proportions and amounts in wt.-% (% by weight) of any of the constituents given hereinafter, which are present in each of the compositions add up to 100 wt.-%, based in each case on the total weight of the respective composition.

### Pretreatment Method

A first subject-matter of the present invention is a method for pretreatment of at least one surface of a substrate, wherein said surface is at least partially made of at least one metal and/or alloy thereof. The method comprises at least steps 1) and 2).

The term “pretreatment” as used herein is preferably used in accordance with the term “surface pretreatment” as defined in Rompp Lexikon “Lacke und Druckfarben” (Publisher: Ulrich Zorll, Editor: Hans-Jürgen P. Adler—Stuttgart; New York: Thieme, 1998; term: “Oberflächenvorbehandlung” page 417). On metallic substrates or substrates having metallic surfaces, according to DIN 50902:1994-07, the first step(s) of a surface treatment is/are often one or more (chemical) cleaning step(s) with aqueous or non-aqueous cleaning compositions (also called “surface preparation step”).

The term “chemical pretreatment” is used in accordance with EN ISO 4618:2006 (E/F/D) (term: 2.41 “chemical pre-treatment”), which represents any chemical process applied to a surface prior to the application of a coating material. According to this standard, e.g., treatments like chromatizing and phosphatizing, which can be subsumed under the term “conversion treatment”, belong to the chemical pretreatment and thus are to be distinguished from (subsequent) coating steps, wherein coating materials, i.e., coating compositions such as powder coating compositions, electrodeposition coating compositions, aqueous or non-aqueous liquid coating materials are applied. Besides conversion treatments such as chromatizing and phosphating, the chemical surface pretreatment may be achieved with passivation compositions and thin-film forming compositions in general, including aqueous fluoride anions containing compositions such as the composition AAC, which is mandatorily used as chemical pretreatment composition in step 1).

In accordance with the above internationally valid definitions of a “pretreatment” of metallic substrates, the pretreatment method according to the present invention preferably encompasses surface preparing cleaning steps besides the chemical pretreatment step 1) and the rinsing step 2).

Preferably, the pretreatment method does not contain any step involving any treatment with chromium ions such as Cr(VI) ions and/or Cr(III) ions. Preferably, the chemical pretreatment step 1) is the only chemical pretreatment step of the pretreatment method. Hence, preferably, other chemical pretreatment compositions than the composition AAC are not used.

### Substrate

The substrate has at least one surface, which is at least partially made of at least one metal and/or alloy thereof. Hence, the substrate has at least one metallic surface.

Preferably, the at least one surface of the substrate is at least partially made of at least one metal and/or alloy thereof, more preferably at least partially made of steel, preferably steel selected from the group consisting of bare steel, cold rolled steel (CRS), hot rolled steel, galvanized steel such as hot dip galvanized steel (HDG), alloy galvanized steel and aluminized steel (such as, for example, Galvalume®, Galvannealed® or Galfan®), aluminum, aluminum alloys including aluminum magnesium alloys, aluminum magnesium silicon alloys, aluminum copper alloys, aluminum zinc alloys, and aluminum zinc copper alloys, and zinc alloys such as Zn/Mg alloys and Zn/Ni alloys as well as Zn/Mg/Al alloys.

Preferably, not only at least one surface of the substrate is metallic, but the substrate as such is metallic. The term “metallic substrate” encompasses, in accordance with the general understanding of said term, any substrate having a surface comprising one or more pure metals and/or alloys thereof. If a substrate comprises areas of different metals, such substrate is herein denoted as “multi-metallic substrate” as a subclass of metallic substrates.

Preferably, the substrate used is an electrically conductive substrate, which are used customarily and known to the skilled person. The substrate can have all sorts of geometry and shape such as coils and sheets as well as parts such as automotive parts including vehicle parts such as wheel parts, these vehicle parts in turn including also electrical vehicle parts such as battery housings and other workpieces. Particularly suitable substrates are parts of vehicle bodies or complete bodies of automobiles for production.

### Optional Steps Performed Prior to Step 1)

Prior to step 1) one or more of the following optional steps can be performed in this order:
Step A-1): cleaning and optionally subsequently rinsing the surface of the substrate,
Step B-1): subjecting the surface of the substrate to acidic or alkaline pickling, i.e., etching, and subsequently rinsing the surface of the substrate,
Step C-1): contacting the surface of the substrate with an aqueous composition comprising at least one mineral acid, said aqueous composition being different from compositions AC and AAC or alternatively with an aqueous alkaline composition or pH-neutral aqueous composition, each of these compositions being also different from composition AC, and
Step D-1): rinsing the surface of the substrate obtained after the contact according to step C-1) and/or B-1).

Alternatively, steps A-1) and B-1) may be performed in one step, which is preferred. Preferably, both steps A-1) and B-1) are performed.

Optional step C-1) preferably serves to remove oxides, undesired alloy components, the skin, brushing dust etc. from the surface of the substrate and to thereby activate the surface for the subsequent conversion treatment in step 1).

Preferably, the at least one mineral acid of the composition in step C-1) is sulfuric acid and/or nitric acid, more preferably sulfuric acid.

Rinsing step D-1) and the optional rinsing being part of step A-1) are preferably performed by using deionized water or tap water. Preferably, step D-1) is performed by using deionized water.

### Step 1) and Composition AAC

According to step 1) of the pretreatment method the at least one surface of the substrate is contacted at least in portion with an acidic aqueous composition AAC, which at least contains fluoride anions, to form a film at least in portion on said surface.

Acidic aqueous composition AAC represent a chemical pretreatment composition. By performing step 1) a conversion film is formed on the surface of the substrate, which has been in contact with the acidic aqueous composition AAC.

The term “at least in portion” preferably means in this context, in accordance with the general understanding of said term, that in some cases it might be desired or sufficient to contact not the whole surface of the substrate with the chemical pretreatment composition AAC. If only part of the metallic surface is contacted with the respective composition, it is typically the same part for all steps of the method. However, generally, it is desired to contact the whole surface of the metallic substrate with the respective compositions.

The “contacting” according to step 1) can be a spraying, a dipping or a roll coating step. The composition AAC can also be applied by flooding the surface or even manually by wiping or brushing. Preferred is spraying, dipping or roll coating.

The treatment time, i.e., the period of time the surface is contacted with the acidic aqueous composition AAC in step 1), is preferably from 15 seconds to 20 minutes, more preferably from 30 seconds to 10 minutes, and most preferably 45 seconds to 5 minutes, as for example 1 to 3 minutes.

The temperature of the acidic aqueous composition AAC used in step 1) s preferably of from 5 to 50 °C, more preferably of from 15 to 45 °C and most preferably from 25 to °C.

The acidic aqueous composition AAC can be used as a dip coat bath. However, it can also be applied by virtually any conventional coating procedure like, e.g., spray coating, roll coating, brushing, wiping etc. as outlined above in connection with step 1). Spraying and dipping are preferred.

The acidic aqueous composition AAC used in step 1) is preferably free of any chromium ions such as Cr(VI) cations and/or Cr(III) cations. The acidic aqueous composition AAC used in step 1) is preferably free of any phosphonate anions and/or phosphate anions.

The term “aqueous” with respect to the inventively used composition AAC in the sense of the present invention preferably means that the composition AAC is a composition containing at least 50 wt.-%, preferably at least 60 wt.-%, more preferably at least 70 wt.-% in particular at least 80 wt.-%, most preferably at least 90 wt.-% of water, based on its total content of organic and inorganic solvents including water. Thus, the composition AAC may contain at least one organic solvent besides water-however, in an amount lower than the amount of water present.

Preferably, the acidic aqueous composition AAC contains at least 50 wt.-%, preferably at least 60 wt.-%, more preferably at least 70 wt.-% in particular at least 80 wt.-%, most preferably at least 90 wt.-% of water, in each case based on its total weight.

The acidic aqueous composition AAC preferably has a pH value in a range of from in a range of from 0.5 to 6.5. Preferably, the pH value is measured at room temperature (23 °C). The pH value of the acidic aqueous composition is more preferably in the range of from 1.0 to 6.0, still more preferably of from 2.0 or 3.0 to 5.5. The pH can be preferably adjusted by using nitric acid, aqueous ammonia and/or sodium carbonate if necessary.

The total amount of all components (constituents) present in the composition AAC adds up to 100 wt.-%. Composition AAC can be a dispersion or solution. Preferably, it is a solution.

Preferably, the acidic aqueous composition AAC comprises fluoride anions in an amount in a range of from 10 to 2000 mg/L, more preferably of from 15 to 1500 mg/L, even more preferably of from 20 to 1000 mg/L, still more preferably of from 25 to 500 mg/L, yet more preferably of from 25 to 500 mg/L, in each case calculated as fluorine. As it will be outlined hereinafter, preferably complex fluorides such as complexes of zirconium, titanium and/or hafnium formed with fluoride ions are present in the composition AAC, e.g., by coordination of fluoride anions to zirconium, titanium and/or hafnium cations in the presence of water. Alternatively, fluoride anions may be generated by adding other water-soluble fluorine compounds, e.g., fluorides (other than complex fluorides of Ti, Zr and/or Hf) as well as hydrofluoric acid to the composition. The free fluoride content is determined by means of a fluoride ion sensitive electrode according to the method disclosed in the ‘methods’ section.

Preferably, the acidic aqueous composition AAC comprises at least one metal cation selected from the group consisting of titanium, zirconium and hafnium ions, and mixtures thereof, more preferably selected from the group of titanium and zirconium ions and mixtures thereof, even more preferably selected from zirconium ions.

Preferably, the acidic aqueous composition AAC comprises at least one organosilane, preferably in an amount of from 5 to 1000 mg/L, more preferably of from 5 to 500 mg/L. Examples are, e.g., (3-aminopropyl) trimethoxysilane, (3-aminopropyl)triethoxysilane, N-2-aminoethyl-3-aminopropyltrimethoxysilane, (3-mercaptopropyl) trimethoxysilane, (3-mercaptopropyl)triethoxysilane, (3-glycidyloxypropyl) trimethoxysilane and/or (3-glycidyloxypropyl)triethoxysilane, and/or vinyltrimethoxysilane. The organosilane is preferably present in a hydrolyzed form thereof.

Preferably, the acidic aqueous composition AAC comprises at least one metal cation selected from the group consisting of titanium, zirconium and hafnium ions, and mixtures thereof, in an amount in a range of from 5 to 2000 mg/L, more preferably of from 7.5 to 1500 mg/L, even more preferably of from 10 to 1000 mg/L, still more preferably of from 15 to 500 mg/L, yet more preferably of from 20 to 300 mg/L, in each case calculated as metal. Preferably, a precursor metal compound is used to generate the at least one metal cation. Preferably, the precursor metal compound is water-soluble. Solubility is determined at a temperature of 20 °C and atmospheric pressure (1.013 bar). Particularly preferred zirconium, titanium and/or hafnium compounds are the complex fluorides of these metals. The term “complex fluoride” includes the single and multiple protonated forms as well as the deprotonated forms. It is also possible to use mixtures of such complex fluorides. Complex fluorides in the sense of the present invention are complexes of zirconium, titanium and/or hafnium formed with fluoride ions in the composition, e.g., by coordination of fluoride anions to zirconium, titanium and/or hafnium cations in the presence of water. The content of the at least one metal cation can be monitored and determined by the means of ICP-OES (optical emission spectroscopy with inductively coupled plasma). Said method is described hereinafter in the ‘method’ section.

Optionally, composition AAC may comprise further constituents such as other metal cations (other than Zr, Ti and/or Hf) and/or at least one water-soluble polymer such as a water-soluble polymer having at least one kind of functional groups selected from acid groups, hydroxyl groups, and mixtures thereof. Solubility is determined at a temperature of 20 °C and atmospheric pressure (1.013 bar). Preferably, the at least one water-soluble polymer is a homopolymer or copolymer obtainable from polymerization of at least one kind of ethylenically unsaturated monomers, wherein at least part of said monomers bear at least one kind of functional groups selected from acid groups, hydroxyl groups, and mixtures thereof, more preferably is a homopolymer or copolymer obtainable from polymerization of at least one kind of vinyl monomers and/or (meth)acrylic monomers, wherein at least part of said monomers bear at least one kind of functional groups selected from acid groups, hydroxyl groups, and mixtures thereof.

Preferably, a conversion layer formed after drying or curing, preferably drying, the film obtainable after step 1) (and subsequent to rinsing step 2)), has a coating weight determined by XRF (X-ray fluorescence spectroscopy) of:

0.5 to 500 mg/m², more preferably 1 to 400 mg/m², even more preferably 3 to 350 mg/m², still more preferably 5 to 300 mg/m², of zirconium, titanium and/or hafnium ions, preferably of zirconium and/or titanium, in particular of zirconium, each calculated as metal.

### Step 2) and Composition AC

According to step 2) of the pretreatment method the film obtained after step 1) is rinsed prior to any optional curing and/or drying of said film with an aqueous composition AC, which is different from acidic aqueous composition AAC, and which contains at least one kind of alkaline earth metal ions.

Aqueous composition AC used in rinsing step 2) preferably represent a “rinsing composition”. This term preferably defines, in accordance with the general understanding of this term, a composition which removes excessive parts of a composition, which was contacted with the metallic surface in the step directly preceding the rinsing step, wherein the rinsing composition is used-in this case, which was contacted with composition AAC in step 1).

Preferably, the at least one kind of alkaline earth metal ions is present in the aqueous composition AC in an amount in a range of from 5 to 2000 ppm, more preferably of from 5 to 1500 ppm, still more preferably of from 5 to 1000 ppm, even more preferably of from 10 to 1000 ppm, still more preferably of from 15 to 800 ppm, yet more preferably of from 20 to 750 ppm, still more preferably of from 25 to 600 ppm, even more preferably of from 35 to 500 ppm, yet more preferably of from 45 to 400 ppm, still more preferably of from 50 to 300 or 250 ppm, in each case calculated as alkaline earth metal. ICP-OES can be used as well for determining the amount.

Preferably, the at least one kind of alkaline earth metal ions present in the aqueous composition AC is selected from beryllium cations, magnesium cations, calcium cations, strontium cations, barium cations and mixtures thereof, more preferably selected from, magnesium cations, calcium cations, and mixtures thereof, most preferably selected from magnesium cations.

Preferably, the aqueous composition AC is obtainable by dissolving at least one kind of an alkaline earth metal salt into water. All kinds of suitable salts can be used. Exemplary salts are salts selected from alkaline earth metal nitrates, sulfates, acetates, and mixtures thereof. In case, acetates are used, preferably the pH value of the aqueous composition AC is adjusted by making use of at least one pH adjusting compound or salt.

Preferably, the aqueous composition AC is free or essentially free of fluoride anions.

Preferably, the aqueous composition AC comprises water in an amount of at least 80 wt.-%, more preferably of at least 85 wt.-%, still more preferably of at least 90 wt.-%, even more preferably of at least 95 wt.-%, still more preferably of at least 98 wt.-%, yet more preferably of at least 99 wt.-%, in each case based on the total weight of the composition AC.

Preferably, the aqueous composition AC has a temperature in a range of from 15 to 55 °C, more preferably of from 17 to 50 °C.

### Optional Step 2a)

Optionally, a further rinsing step can be performed after step 2), according to which the film obtainable after step 2) is rinsed with water, preferably with deionized water.

### Optional Step 2b)

Optional step 2b) is a step, wherein the film obtained after step 2) or optionally after step 2a) is dried and/or cured, preferably dried.

Drying and/or curing may be performed, when in a step 3) as outlined hereinafter, e.g., a powder coating composition is applied as coating material composition. However, step 2b) is only optional and, hence, further method steps such as step 3) may be carried out without drying and/or curing the film obtained after having performed rinsing step 2). In particular, it is possible to apply a coating material composition such as an electrodeposition coating material composition in a step 3) as outlined hereinafter onto a wet film obtained after having performed rinsing step 2).

The drying or curing step 2b) may be preferably performed (if performed at all), e.g., at a temperature in the range of 15 °C to 100 °C, more preferably at a temperature in the range of 18 °C to 95 °C, in particular at a temperature in the range of 20 °C to 90 °C. “Drying” in the sense of the present invention means physical drying by evaporation of in particular water originally present in the composition(s) used, whereas “curing” further includes a chemical reaction between at least two constituents originally present in the composition(s) and/or between at least one constituent originally present in the composition(s) and a suitable functional group present on the metallic surface or in the conversion film, e.g., in case a water-soluble polymer was present in composition AAC.

### Method of Applying at Least One Coating Film

A further subject-matter of the present invention is a method of applying at least one coating film onto at least one surface of a substrate, the method comprising at least steps 1) and 2) as defined hereinbefore and hereinafter and, further, a step 3), namely
3) applying a coating material composition comprising at least one film-forming polymer onto an optionally dried and/or optionally cured, preferably optionally dried, film, which in turn is obtainable after having performed rinsing step 2), optionally after having further dried and/or cured the film obtained after rinsing step 2).

All preferred embodiments described above herein in connection with the pretreatment method and preferred embodiments thereof are also preferred embodiments of the method of applying at least one coating film onto at least one surface of a substrate.

Preferably, the coating material composition applied in step 3) is an electro-depositable, preferably a cathodically depositable, coating material composition, wherein the at least one film-forming polymer present therein preferably is an electro-depositable, preferably a cathodically depositable, polymer. The substrate used is then, of course, preferably an electrically conductive substrate. Preferably, the coating material composition applied in step 3) such as an electro-depositable, preferably a cathodically depositable, coating material composition is applied onto the wet film obtained after having performed rinsing step 2).

Electrodeposition coating (electrocoat) material compositions are coating materials which comprise polymers as binders including optionally crosslinkers, pigments and/or fillers, and, frequently, additives. In general, there are anodically and cathodically depositable electrocoat materials. Cathodically depositable materials, which are preferred, are, e.g., disclosed in EP 1 041 125 A1, DE 197 03 869 A1 and in WO 91/09917 A2.

Preferably, the electrodeposition coating (electrocoat) material compositions used are aqueous.

Any polymer is suitable as cathodically depositable polymer as long as it is cathodically depositable. Preferred are poly(meth)acrylates, (meth)acrylate copolymers, and epoxide polymers. Most preferred are epoxide-amine adducts. An epoxide-amine adduct for the purposes of the present invention is a reaction product of at least one epoxy resin and at least one amine. Epoxy resins used are more particularly those based on bisphenol A and/or derivatives thereof. Amines reacted with the epoxy resins are primary and/or secondary amines or salts thereof and/or salts of tertiary amines. The at least one epoxide-amine adduct used is preferably a cationic, epoxide-based and amine-modified resin.

At least one crosslinking agent can be present in the electrodeposition coating material composition, which is selected from the group consisting of blocked polyisocyanates, free polyisocyanates, amino resins, and mixtures thereof.

The term “blocked polyisocyanates” is known to the skilled person. Blocked polyisocyanates which can be utilized are polyisocyanates having at least two isocyanate groups (diisocyanates in case of precisely two isocyanate groups), but preferably having more than two, such as, for example, 3 to 5 isocyanate groups, wherein the isocyanate groups have been reacted, so that the blocked polyisocyanate formed is stable in particular with respect to hydroxyl groups and amino groups such as primary and/or secondary amino groups at room temperature, i.e., at a temperature of 18 to 23 °C, but at elevated temperatures, as for example at ≥80 °C, ≥110 °C, ≥130 °C, ≥140 °C, ≥150 °C, ≥160 °C, ≥170 °C, or ≥180°, reacts with conversion and with formation of urethane and/or urea bonds, respectively.

Amino resins (aminoplast resins) are likewise known to the skilled person. Amino resins used are preferably melamine resins, more particularly melamine-formaldehyde resins, which are likewise known to the skilled person. Preference, however, is given to using no amino resins such as melamine-formaldehyde resins as crosslinking agents.

The electrodeposition coating material composition preferably is a one-component (1K) coating composition. For this reason, the electrodeposition coating composition preferably contains no free polyisocyanates.

The electrodeposition coating material composition may contain at least one pigment and/or filler. The term “filler” is known to the skilled person, from DIN 55943 (date: October 2001), for example. “Fillers” for the purposes of the present invention preferably are components, which are substantially, preferably entirely, insoluble in the application medium, such as the electrodeposition coating material composition for example, and which are used in particular for increasing the volume. “Fillers” in the sense of the present invention preferably differ from “pigments” in their refractive index, which for fillers is <1.7. All conventional fillers and pigments can be used.

Step 3) is preferably performed by immersing the substrate obtained after step 2) bearing a dried or cured, preferably dried, film, which in turn is obtainable from drying or curing the film obtainable after rinsing step 2) into an electrodeposition coating bath, which comprises the electrodeposition coating material composition, connecting the substrate as cathode, depositing a coating film CF obtained from the electrodeposition coating material composition on the substrate using direct current, removing the coated substrate from the electrodeposition coating bath, and baking the coating film CF deposited on the substrate. The voltage applied is preferably in a range from 50 to 500 volts. The electrodeposition coating bath preferably has a bath temperature in a range from 20 to 45 °C.

### Substrate Obtainable by Pretreatment Method or Method of Applying at Least One Coating Film

A further subject-matter of the present invention is a substrate obtainable by the inventive pretreatment method comprising at least steps 1) and 2) or by the inventive method of applying at least one coating film onto at least one surface of a substrate comprising at least steps 1) and 2) or by the inventive pretreatment method as well as step 3).

All preferred embodiments described above herein in connection with the pretreatment method and the method of applying at least one coating film onto at least one surface of a substrate and preferred embodiments thereof are also preferred embodiments of the inventive substrate.

### Use of the Aqueous Composition AC

A further subject-matter of the present invention is a use of an aqueous composition AC as defined hereinbefore and hereinafter, e.g., in connection with step 2) of the inventive pretreatment method,
for rinsing a film obtainable from applying an acidic aqueous and fluoride anions containing composition, preferably from applying acidic aqueous composition AAC as defined hereinbefore and hereinafter, e.g., in connection with step 1) of the inventive pretreatment method, at least in portion onto at least one surface of a substrate, wherein said surface is at least partially made of at least one metal and/or alloy thereof, and wherein rinsing is to be performed prior to any optional curing and/or drying of said film,
and/or
for at least partially reducing the fluoride content of a film obtainable from applying an acidic aqueous and fluoride anions containing composition, preferably from applying acidic aqueous composition AAC as defined hereinbefore and hereinafter, e.g., in connection with step 1) of the inventive pretreatment method, at least in portion onto at least one surface of a substrate, wherein said surface is at least partially made of at least one metal and/or alloy thereof, preferably by rinsing said film with the aqueous composition AC prior to any optional curing and/or drying of said film,
and/or
for improving the homogeneity of the film build and/or for reducing the mapping of a coating film CF at least in one of its areas, the coating film CF being obtained from applying an electrodeposition coating material composition over a cured or dried film, which in turn is obtainable from applying an acidic aqueous and fluoride anions containing composition, preferably from applying acidic aqueous composition AAC as defined hereinbefore and hereinafter, e.g., in connection with step 1) of the inventive pretreatment method, at least in portion onto at least one surface of a substrate, wherein said surface is at least partially made of at least one metal and/or alloy thereof, preferably by rinsing said film with the aqueous composition AC prior to any optional curing and/or drying of said film and prior to the application of coating film CF.

All preferred embodiments described above herein in connection with the pretreatment method and the method of applying at least one coating film onto at least one surface of a substrate as well as the inventive substrate, and preferred embodiments thereof are also preferred embodiments of the inventive use.

### Kit-of-Parts

A further subject-matter of the present invention is a kit-of-parts comprising, preferably consisting of,
an acidic aqueous composition AAC, which at least contains fluoride anions, as defined hereinbefore and hereinafter, e.g., in connection with step 1) of the inventive pretreatment method, and
an aqueous composition AC, which contains at least one kind of alkaline earth metal ions and is different from acidic aqueous composition AAC, as defined hereinbefore and hereinafter, e.g., in connection with step 2) of the inventive pretreatment method.

The term ‘kit of parts’ herein means, in accordance with common usage, that it comprises at least two spatially separate constituents, which are functionally unitary through purposeful use.

All preferred embodiments described above herein in connection with the pretreatment method and the method of applying at least one coating film onto at least one surface of a substrate as well as the inventive substrate and the inventive use, and preferred embodiments thereof are also preferred embodiments of the inventive kit-of-parts.

### Methods

### 1. Free Fluoride Content Determination

The free fluoride content is determined by means of a fluoride ion selective electrode. The electrode is calibrated using at least three master solutions with known fluoride concentrations. The calibration process results in the building of calibration curve. Then the fluoride content is determined by using of the curve.

### 2. ICP-OES

The amounts of certain elements in a sample under analysis, such as of zirconium, titanium, hafnium etc., is determined using inductively coupled plasma atomic emission spectrometry (ICP-OES) according to DIN EN ISO 11885 (date: Sep. 1, 2009). A sample is subjected to thermal excitation in an argon plasma generated by a high-frequency field, and the light emitted due to electron transitions becomes visible as a spectral line of the corresponding wavelength and is analyzed using an optical system. There is a linear relation between the intensity of the light emitted and the concentration of the element in question. Prior to implementation, using known element standards (reference standards), the calibration measurements are carried out as a function of the particular sample under analysis. These calibrations can be used to determine concentrations of unknown solutions such as the concentration of the amount of titanium, zirconium and hafnium.

### 3. Coating Weight

XRF (X-ray fluorescence spectroscopy) is used for determining the coating weight in mg/m² of a certain element in a layer such as the conversion layer resulting from applying the chemical pretreatment composition to a substrate.

### 4. Paint Thickness

The paint thickness (dry film layer thickness) of the electrodeposition coating layers was measured in μm according to DIN EN ISO 2178:2016-11 by making use of the Dualscope® MP20E-S tool from the company Fischer. Each value measured represents the average of 5 measurements. By measuring the dry film layer thicknesses, the film build can be determined as well as the differences in film build (mapping).

### EXAMPLES

The following examples further illustrate the invention, but are not to be construed as limiting its scope.

### 1. Products and Materials Used

A commercially available (Chemetall GmbH) product has been used as chemical pretreatment composition (CPC), i.e., the product Oxsilan® 9835, which is an acidic aqueous composition containing inter alia fluoride anions as well as zirconium ions.

Different aqueous post-rinse compositions have been used (comparatively as well as inventively used compositions), i.e.
PRC1 (comparative): deionized water;
PRC2 (comparative): aqueous alkaline composition (deionized water, to which NaOH has been added until a pH value of 10 was reached);
PRC3 (comparative): aqueous composition comprising sodium nitrite (50 ppm, calculated as NO₂); and
PRC4a to PRC4d
(all inventive): aqueous compositions comprising magnesium nitrate; PRC4a: 20 ppm, calculated as Mg; PRC4b: 100 ppm, calculated as Mg; PRC4c: 200 ppm, calculated as Mg; PRC4d: 980 ppm, calculated as Mg.

### 2. Method (Pretreatment Steps, Post-Rinse and Electrocoating)

A hot-dip galvanized steel substrate (HDG substrate) was provided in form of a metal panel.

The substrate was cleaned by making use of a commercially available alkali cleaner having a pH value of about 10.5 (at 55 °C for about 1.5 minutes by spray or dip application). Then, rinsing with tap water and subsequent rinsing with deionized water was performed (for 30 seconds each).

Two different approaches for the subsequent contacting step were performed:

### Approach 1:

A contacting step was carried out, wherein the overall surface of the substrate was contacted with the chemical pretreatment composition CPC described hereinbefore in item 1. for 3 minutes by immersion. Afterwards, 50% of the surface area of each substrate was contacted with composition CPC for another 3 minutes by further immersion. Hence, 50% of the surface area of each substrate was contacted for in total 6 minutes with composition CPC to simulate a longer treatment time, the resulting respective surface area being referred to hereinafter as “runner area”.

### Approach 2:

A contacting step was carried out, wherein the overall surface of the substrate was contacted with the chemical pretreatment composition CPC described hereinbefore in item 1. for 3 minutes by immersion. Subsequently, composition CPC was let run over a part of the surface area of the substrate for another 3 minutes using a dropping funnel. The resulting respective surface area with a contact time of 6 min is hereinafter referred to as “runner area”.

“Runner areas” of the surface are areas that have been longer in contact with the composition CPC than planned in a non-controlled manner in order to be able to observe undesired mapping in these areas. The remaining surface area of each substrate was contacted for in total only 3 minutes with composition CPC, the resulting respective surface area being referred to hereinafter as “non-runner area”.

The composition (CPC) had been heated in each case to 30 °C before being applied.

Following the contacting step according to approaches 1 or 2, a post-rinsing step was performed by making use of one of the compositions PRC1, PRC2, PRC3, PRC4a, PRC4b, PRC4c or PRC4d for 1 minute at ambient temperature (18 to 25 °C). The overall surface of all substrates was post-rinsed in this manner.

Following the post-rinsing step, a final rinsing with deionized water was performed (for seconds).

Next, a drying step via air blowing was performed.

Finally, the substrates obtained were each coated with a commercial electrodeposition coating composition, i.e., the commercially available product CathoGuard® 800. Electrodeposition coating took place over the course of 2 minutes with a deposition voltage of 180-260 V (voltage ramps: 4 s, 30 s or 60 s) at a bath temperature of 31-33 °C. The substrates were subsequently baked at 175 °C (substrate temperature) for 25 minutes.

### 3. Investigation of Properties of the Coated Substrates

3.1 The total amount of F present in the layer formed from applying the chemical pretreatment composition CPC was determined in the form of the quotient of the total coating weight of Zr (resulting from the zirconium cations present in CPC) in mg/m² and the total amount of F (resulting from the fluoride anions present in CPC) in mg/m² (hereinafter also referred to as “Zr/F-ratio”) according to the method defined in the ‘method’ section. A higher Zr/F-ratio indicates a higher or more efficient reduction/removal of F from the layer, which is desired. In Tables 1a and 1b displayed hereinafter the resulting Zr/F-ratios determined are summarized for both approaches 1 and 2 described hereinbefore in item 2.

TABLE 1a
(performance of contacting step via approach 1):

| Chemical pretreatment | Post-rise | |
|---|---|---|
| composition used | composition used | Zr/F-ratio |
| CPC | PRC1 | 9.5 |
| | (comparative) | |
| CPC | PRC2 | 9.6 |
| | (comparative) | |
| CPC | PRC3 | 9.6 |
| | (comparative) | |
| CPC | PRC4a | 10.6 |
| | (inventive) | |
| CPC | PRC4b | 10.2 |
| | (inventive) | |
| CPC | PRC4c | 11.9 |
| | (inventive) | |
| CPC | PRC4d | 11.3 |
| | (inventive) | |

TABLE 1b
(performance of contacting step via approach 2):

| Chemical pretreatment | Post-rise | |
|---|---|---|
| composition used | composition used | Zr/F-ratio |
| CPC | PRC1 | 5.8 |
| | (comparative) | |
| CPC | PRC4c | 10.5 |
| | (inventive) | |

As it is evident from Tables 1a and 1b a post-rinsing using one of PRC4a to PRC4d after a chemical pretreatment with a fluoride anions containing composition CPC leads to a reduction of the amount of F in the chemical pretreatment layer.

3.2 In addition, the paint thicknesses (dry layer thicknesses) of the electrodeposition coating layers in μm have been determined as well according to the method defined in the ‘method’ section and are given in Table 1c and 1d. The influence of the type of post-rinse composition used on the paint thicknesses of the “runner area” of the surfaces has been investigated. The results are displayed in Tables 1c and 1d. The respective paint thicknesses of “non-runner areas” of the surfaces of the same panels are given as well in Tables 1c and 1d. It can be seen that that the post-rinse treatment has only a minor influence on the obtained electrodeposition coating layer thicknesses of the “non-runner areas”, while having a significant impact on the obtained electrodeposition coating layer thicknesses in the “runner areas”. This ultimately results in levelling out the differences in electrodeposition coating layer thicknesses between the “non-runner” and the “runner area”, which is desired.

TABLE 1c
(performance of contacting step via approach 1):

| | | | | Difference |
|---|---|---|---|---|
| | | | | paint |
| | Paint | | | thickness |
| | thickness | | | between |
| | of “runner | | | “runner |
| | area”, when | | | area” |
| | post-rinsed | | | (after post- |
| | with PRC1 | Paint | | rinse with |
| | (compar- | thickness | | PRC1 or with |
| | ative; | of “runner | | of one of |
| | reference | area”, when | Paint | PRC2, PRC3 |
| | example for | post-rinsed | thickness | or PRC4a to |
| | each of | with one of | of | PRC4d) and |
| | experiment | PRC2, PRC3 | “non- | “non- |
| | nos | or PRC4a | runner | runner |
| Experiment | 2 to 7) | to PRC4d | area” | area” |
| no. | [μm] | [μm] | [μm] | [μm] |
| 1 | 30 | — | 27 | 3 |
| 2 | 30 | 30 | 26 | 4 |
| | | (PRC2, | | |
| | | comparative) | | |
| 3 | 30 | 30 | 27 | 3 |
| | | (PRC3, | | |
| | | comparative) | | |
| 4 | 34 | 31 | 31 | 0 |
| | | (PRC4a, | | |
| | | inventive) | | |
| 5 | 32 | 30 | 30 | 0 |
| | | (PRC4b, | | |
| | | inventive) | | |
| 6 | 33 | 30 | 30 | 0 |
| | | (PRC4c, | | |
| | | inventive) | | |
| 7 | 31 | 29 | 29 | 0 |
| | | (PRC4d, | | |
| | | inventive) | | |

TABLE 1d
(performance of contacting step via approach 2):

| | | | | Difference |
|---|---|---|---|---|
| | Paint | | | paint |
| | thickness | | | thickness |
| | of “runner | | | between |
| | area”, when | | | “runner |
| | post-rinsed | | | area” |
| | with PRC1 | | | (after post- |
| | (compar- | Paint | | rinse with |
| | ative; | thickness | | PRC1 or with |
| | reference | of “runner | Paint | of one of or |
| | example for | area”, when | thickness | PRC4b to |
| | each of | post-rinsed | of | PRC4d) and |
| | experiment | with one | “non- | “non- |
| | nos | of PRC4b | runner | runner |
| Experiment | 8 to 10) | to PRC4d | area” | area” |
| no. | [μm] | [μm] | [μm] | [μm] |
| 8 | 26 | 21 | 20 | 1 |
| | | (PRC4b, | | |
| | | inventive) | | |
| 9 | 26 | 20 | 19 | 1 |
| | | (PRC4c, | | |
| | | inventive) | | |
| 10 | 26 | — | 20 | 6 |

As it is evident from Tables 1c and 1d a post-rinsing using one of PRC4a to PRC4d after a chemical pretreatment with a fluoride-anions containing composition CPC significantly reduces the paint thickness of the electrodeposition coating layer in the “runner area”. A paint thickness difference (difference in film build and thus undesired mapping) between “runner area” and “non-runner area” of more than 1.5 μm—as observed when using one of PRC1 to PRC3 instead-is not acceptable, because it is visually detectable even after topcoat application (to be subsequently applied after application of the electrodeposition coating layer and optionally further layers such as basecoat layers) and, furthermore, requires extra grinding operations after the electrodeposition coat application in order to achieve a uniform and homogeneous film build. As outlined above a post-rinsing with deionized water (PRC1) or making use of conventional post-rinse compositions like NaOH-containing compositions (PRC2) or sodium nitrite containing compositions (PRC3) has no effect in this regard, as it is evident also from Tables 1c and 1d.

1. A method for pretreatment of at least one surface of a substrate, wherein said surface is at least partially made of at least one metal and/or alloy thereof, the method comprising at least steps 1) and 2), namely,
1. contacting the at least one surface of the substrate at least in portion with an acidic aqueous composition AAC, which at least contains fluoride anions in an amount in a range of from 10 to 2000 mg/L, calculated as fluorine, and further comprises at least one metal cation selected from the group consisting of titanium, zirconium and hafnium ions and mixtures thereof, to form a film at least in portion on said surface, and
2. rinsing the film obtained after step 1) prior to any optional curing and/or optional drying of said film with an aqueous composition AC, which is different from acidic aqueous composition AAC, and which contains at least one kind of alkaline earth metal ions.

2. The method according to claim 1, wherein the at least one kind of alkaline earth metal ions is present in the aqueous composition AC in an amount in a range of from 5 to 2000 ppm, calculated as alkaline earth metal.

3. The method according to claim 1, wherein the at least one kind of alkaline earth metal ions present in the aqueous composition AC is selected from the group consisting of beryllium cations, magnesium cations, calcium cations, strontium cations, barium cations and mixtures thereof.

4. The method according to claim 1, wherein the aqueous composition AC is obtained by dissolving at least one kind of an alkaline earth metal salt into water.

5. The method according to claim 1, wherein the aqueous composition AC comprises water in an amount of at least 80 wt.-% based on the total weight of the composition AC.

6. The method according to claim 1, wherein the acidic aqueous composition AAC comprises fluoride anions in an amount in a range of from 15 to 1500 mg/L, calculated as fluorine.

7. The method according to claim 1, wherein the acidic aqueous composition AAC comprises at least one metal cation selected from the group consisting of titanium and zirconium ions and mixtures thereof.

8. The method according to claim 1, wherein the acidic aqueous composition AAC comprises at least one metal cation selected from the group consisting of titanium, zirconium and hafnium ions, and mixtures thereof, in an amount in a range of from 5 to 2000 mg/L, calculated as metal.

9. The method according to claim 1, wherein the acidic aqueous composition AAC has a pH value in a range of from 0.5 to 6.5.

10. The method according to claim 1, wherein the rinsing step 2) is performed for a period of time in a range of from 10 seconds to 5 minutes.

11. A method of applying at least one coating film onto at least one surface of a substrate, the method comprising at least steps 1) and 2) of claim 1 and, further, a step 3), namely
3) applying a coating material composition comprising at least one film-forming polymer onto an optionally dried and/or optionally cured film, which film in turn is obtained after having performed rinsing step 2), optionally after having further dried and/or cured the film obtained after rinsing step 2).

12. The method according to claim 11, wherein the coating material composition is an electro-depositable coating material composition.

13. A substrate obtained by the method according to claim 11.

14. A method of using an aqueous composition AC of claim 1, the method comprising using the aqueous composition AC
for rinsing a film obtained from applying an acidic aqueous and fluoride anions containing composition at least in portion onto at least one surface of a substrate, wherein said surface is at least partially made of at least one metal and/or alloy thereof, and wherein rinsing is to be performed prior to any optional curing and/or drying of said film,
and/or
for at least partially reducing the fluoride content of a film obtained from applying an acidic aqueous and fluoride anions containing composition at least in portion onto at least one surface of a substrate, wherein said surface is at least partially made of at least one metal and/or alloy thereof, preferably by rinsing said film with the aqueous composition AC prior to any optional curing and/or drying of said film,
and/or
for improving the homogeneity of the film build and/or for reducing the mapping of a coating film CF at least in one of its areas, the coating film CF being obtained from applying an electrodeposition coating material composition over a cured or dried film, which in turn is obtained from applying an acidic aqueous and fluoride anions containing composition at least in portion onto at least one surface of a substrate, wherein said surface is at least partially made of at least one metal and/or alloy thereof.

15. A kit-of-parts comprising
an acidic aqueous composition AAC, which at least contains fluoride anions according to claim 1, and
an aqueous composition AC, which at least contains at least one kind of alkaline earth metal ions and is different from the acidic aqueous composition AAC.

16. The method according to claim 1, wherein the at least one kind of alkaline earth metal ions is present in the aqueous composition AC in an amount in a range of from 5 to 1500 ppm.

17. The method according to claim 1, wherein the at least one kind of alkaline earth metal ions present in the aqueous composition AC is selected from the group consisting of beryllium cations, magnesium cations, strontium cations, barium cations, and mixtures thereof.

18. The method according to claim 1, wherein the aqueous composition AC is obtained by dissolving at least one kind of an alkaline earth metal salt selected from alkaline earth metal nitrates, sulfates, acetates, and mixtures thereof into water.

19. The method according to claim 1, wherein the aqueous composition AC comprises water in an amount of at least 85 wt.-% based on the total weight of the composition AC.

20. The method according to claim 1, wherein the acidic aqueous composition AAC comprises fluoride anions in an amount in a range of from 20 to 1000 mg/L.
